(19) United States
(12) Patent Application Publication
(10) Pub. No.: US 2006/0249069 A1
(43) Pub. Date: Nov. 9, 2006

(54) Flag and flag kit

(76) Inventor: Christopher Paul McCann, Glenwood (ZA)

Correspondence Address: Neil F Markva, 8322 A Traford Lane, Springfield, VA, 22152, US

(21) Appl. No.: 10/554,955

(22) PCT Filed: Apr. 29, 2004
(86) PCT No.: PCT/ZA04/00045

§ 371 Date: May 11, 2006

(30) Foreign Application Priority Data
Apr. 30, 2003 (ZA) 03/3380

(51) Int. Cl. G09F 17/00

(52) U.S. Cl. 116/174

(57) ABSTRACT

This invention provides a flag (1), consisting of a flexible membrane (2), a shaft (3) and distending means comprising rods (4.1) and (4.2). The shaft (3) is hollow and forms a sleeve about a flag staff (7). The flexible membrane (2) has a leading end (5) and a trailing end (6). The leading end (5) is removably attached to the sleeve (3). Each rod (4.1) and (4.2) has a fixing end and a free end. The fixing ends are friction fixed to the sleeve (3) by means of a collar (8) located on the sleeve, and the free ends are retained in pockets (6.1) and (6.2) provided in the trailing end (6). In use, the rods (4.1) and (4.2) exerts a pressure from within the membrane (2), resulting in the distended state of the flag (1) under all weather conditions.

### BACKGROUND TO THE INVENTION

This invention relates to a flag and to a flag kit.

The nouns “flag” and “banner” are accorded the same meaning and are used inter-changeably hereinafter.

The display of flags enjoys universal popularity. Flags had been typically nationalistic flags, such as the South African flag. However, “decorative” flags have become popular in recent years for displaying information, more specifically in the advertising industry. Flags have also become popular as wind direction indicators, such as for example, flags used on golf courses that show golfers wind direction to enable the golfer to compensate for particular wind conditions before playing the shot. These wind direction indicators have also become popular in recent years for displaying information printed thereon.

Out of doors, and at the mercy of vagaries of the wind, flags have a tendency to wind around their staff, which results in a somewhat sorry sight, contrary to the desired effect. The flags do not float in the wind, or are partially hampered, in a period of calm. The sight remains just as unsatisfactory, if not more so, if no one unfurls the flags.

Flags of the kind relevant to the invention described in the present specification are known inter alia from U.S. Pat. Nos. 2,732,823 and 3,091,215, and these flags are provided with a pocket extending diagonally from the lower corner adjacent the staff to the upper corner farthest away from said staff. A reinforcing rib is placed in the pocket. These arrangements are primarily adapted to be used in connection with strong plastic traffic flags. Problems arise, however, when these arrangements are used for flags of conventional fabric because such flags are not kept distended so as to present a natural appearance and information displayed thereon cannot be read easily.

U.S. Pat. No. 5,884,578 describes a flag that comprises a resilient bar being retained in pockets in the upper rim of the flag and the rim of said flag adjacent the staff, respectively. The bar is firmly fixed and extends substantially in the entire plane of the flag so that between its ends it forms a curve extending upwards towards the upper corner of the flag.

The applicant is aware of arrangements in which the flag hangs loosely downwards from a horizontally projecting bar arranged perpendicular to the staff. This flag, however, cannot be kept distended either so as to present a natural appearance.

U.S. Pat. No. 3,595,202 describes fixing the flag to the staff via at least one sleeve coaxial to the staff mounted to rotate freely thereon, the sleeve having a pair of spaced apart discs on its upper portion and on its lower portion and a rotating ring located between the pair of spaced apart discs. Each rotating ring is provided with an arm radially extending therefrom, and a bar being attached to the arms so that the flag may be easily hooked on the bar. Thus, under the effect of the wind and/or the weight of the flag, the flag exerts on the sleeve a rotating torque tending to rotate it and avoid the flag winding therearound.

U.S. Pat. No. 4,603,652 describes a device for fastening a flag on a staff via a sleeve coaxial to the staff mounted to rotate freely on the staff. The device comprises a rod having two ends. The first end is connected to the sleeve so that the rod extends, at least partially, in a plane substantially transverse to the sleeve. The second end of the rod is remote from the sleeve and connected to the flag. The result is that the torque exerted by the flag on the sleeve under the effect of the wind and/or the weight of the flag is increased.

Although the known devices have, in principle, brought some improvements, to the applicant's knowledge, they have not been developed commercially, doubtless due to their relatively complex construction and their inadequacies in use.

The majority of flags known to the applicant are not durable as such flags have a tendency to flutter under windy conditions resulting in the flags tearing.

The object of this invention is to provide a flag that rotates freely on a staff whilst being kept fully distended under all wind and weather conditions. The flag according to the invention provides increased visibility and durability of the flag thereby meeting the demands from the advertising industry.

### SUMMARY OF THE INVENTION

According to this invention there is provided a flag consisting of a flexible membrane attached to a shaft adapted to rotate about an axis in alignment with the axis of the staff of the flag, the membrane being adapted to be held distended normal to the staff and across the plane of the membrane.

In one version of the invention, the axis of rotation is congruent with the axis of the staff.

In another version of the invention, the axis of rotation is parallel to and remote from the axis of the staff.

The shaft is preferably in the form of a sleeve.

The flexible membrane may be held distended by means applying pressure from within the membrane.

The flexible membrane may be removably attached to the shaft.

The flexible membrane may be a textile, fabric or plastic material.

The distending means may be integral with the shaft.

The distending means may be removably fixed to the shaft.

The distending means may be pocketed within the membrane.

According to another aspect of the invention, there is provided a flag kit consisting of a flexible membrane having means for removable attachment of the membrane to a shaft adapted to rotate about an axis in alignment with the axis of a flag staff in use, the membrane being adapted to be held distended normal to the staff of the flag and across the plane of the membrane by means applying pressure from within the membrane and the shaft being provided with means for fixation of the distending means to the shaft in use.

The flexible membrane may be a textile, fabric or plastic material.

The means for removable attachment of the flexible membrane to the shaft may comprise a hook and loop fastener or the like.

In another embodiment of the invention, the attachment means comprises a pocket formed by a seam provided along at least a portion of the leading end of the membrane within which the shaft is located in use.

The means for removable fixation of the distending means to the shaft may comprise a collar, clamp, binder, or any other suitable fastening means.

The distending means may be pocketed within the membrane.

Still further according to the invention, the membrane itself, for use with the flag or banner of the invention, falls within the scope of the invention.

### BRIEF DESCRIPTION OF THE DRAWINGS

Further features of a flag and flag kit in accordance with the invention are described by way of non-limiting examples of the invention, with reference to and as illustrated in the accompanying diagrammatic drawings.

In the drawings:

FIG. 1 shows a side view of a flag in accordance with one embodiment of the invention;

FIG. 2 is a rear view of the flag of FIG. 1;

FIG. 3 is a partially cut away pictorial view of another embodiment of the invention;

FIG. 4 a pictorial view illustrating the manner in which the membrane is attached to the sleeve of the flag of FIG. 3; and

FIG. 5 is side view of a further embodiment of the invention.

FIG. 6 is a side view of another embodiment of the invention.

FIG. 7 is an enlarged pictorial view of the rear of the flag depicted in FIG. 6.

FIGS. 8 to 11 are side views of different layouts of the distending means of the invention.

### DESCRIPTION OF EMBODIMENTS OF THE INVENTION

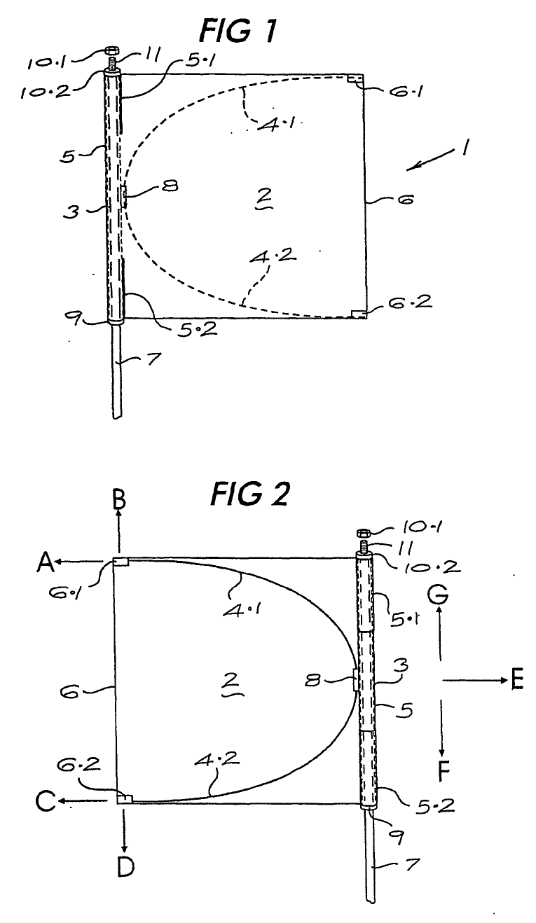

With reference to FIG. 1 and FIG. 2 of the drawings, a flag in accordance with the invention, is designated generally by the reference numeral 1.

The flag 1 consists of a flexible membrane 2, a shaft 3 and distending means comprising rods 4.1 and 4.2.

In the description of the embodiments which follow the adjective “distending” is used in its grammatical sense of applying pressure from within the parameters of the membrane 2.

The flexible membrane 2 is a textile material. In another form of the invention, the flexible membrane is a fabric material. In a further form, the flexible membrane is a plastic material.

The membrane 2 has a leading end 5 and a trailing end 6. The leading end 5 is provided with tubes formed by a seam 5.1 along an upper portion thereof and a seam 5.2 along a lower portion thereof. The trailing end 6 is provided with a pocket 6.1 along a top corner thereof and a pocket 6.2 along a bottom corner thereof.

The shaft 3 is hollow and forms a sleeve about a flag staff 7. The axis of the sleeve 3 is thus congruent with the axis of the staff 7 and is able to rotate freely on the staff 7 in use. The leading end 5 is removably attached the sleeve 3 which is accommodated in the tubes formed by seams 5.1 and 5.2.

In a preferred form of the invention, the leading end 5 is removably attached to the sleeve 3 by means of a hook and loop fastener such as VELCRO or the like provided along at least a portion of the leading end 5. This facilitates the removal and replacement of the membrane on which information is displayed to allow changes to the information displayed on the membrane.

The sleeve 3 may be made of plastic, steel, aluminium, PVC or the like.

The distending means comprises two rods 4.1 and 4.2. Each rod 4.1 and 4.2 has a fixing end and a free end. The fixing ends are friction fixed to the sleeve 3 by means of a collar 8 located on the sleeve 3 so that rods 4.1 and 4.2 are held integral with the sleeve 3. The free ends of the rods 4.1 and 4.2 are retained in pockets 6.1 and 6.2, respectively.

Means alternative to a collar for fixation of the rod to the sleeve may include a clamp, binder or any other suitable fastening means.

In use the free end of the rod 4.1 exerts an outward pressure along the top of the membrane as is illustrated by arrow A in the drawing, as well as an upward pressure, as is illustrated by arrow B. The free end of the rod 4.2 exerts an outward pressure along the bottom of the membrane as is illustrated by arrow C in the drawing, as well as an downward pressure, as is illustrated by arrow D. The fixing end of rod 4.2 exerts a backward pressure along the rod's leading end as is illustrated by arrow E in the drawing, as well as a downward pressure as is illustrated by arrow F. The fixing end of rod 4.2 exerts a backward pressure along the leading end 3 as is illustrated by arrow E in the drawing, as well as an upward pressure as is illustrated by arrow G.

The distending means, consisting of rods 4.1 and 4.2, thus exerts a pressure from within the membrane 2 resulting in the distended state of the flag 1 under all weather conditions.

The rods 4.1 and 4.2 are of a suitable resilient material such as, for example, steel, glass fibre, carbon reinforced material, PVC or the like.

The staff 7 is provided with retaining means in the form of a stop 9, along the length of the staff 7 and, at the top of the staff 7, a nut 10.1 turned onto a threaded length 11 via washer 10.2. Accordingly, the flag can easily be removed from the staff 7 in use and replaced to suit desired changes in the information to be displayed on the flag.

Retaining means alternative to the nut 10.1 may include a plug, cap, circlip or the like.

In use, the flag 1 is mounted on the staff 7 by sliding the sleeve 3 onto the staff 7 until the flag 1 is brought to rest on the staff 7 by means of the stop 9. The flag 1 is then retained on the staff 7 by means of the nut 10.1.

When the flag 1 is no longer required or is to be replaced by another flag, the nut 10.1 is simply unfastened to release the sleeve 3, and hence the flag 1, from the staff 7.

To assemble the flag 1, the sleeve 3 is inserted into the tubes formed by seams 5.1 and 5.2. The rods 4.1 and 4.2 are then fixed integrally to the sleeve 3 by inserting the fixing ends of the rods to friction fit in the collar 8. The free ends of the rods 4.1 and 4.2 are then retained in the pockets 6.1 and 6.2, respectively.

To disassemble the flag 1, the steps of assembly are simply reversed.

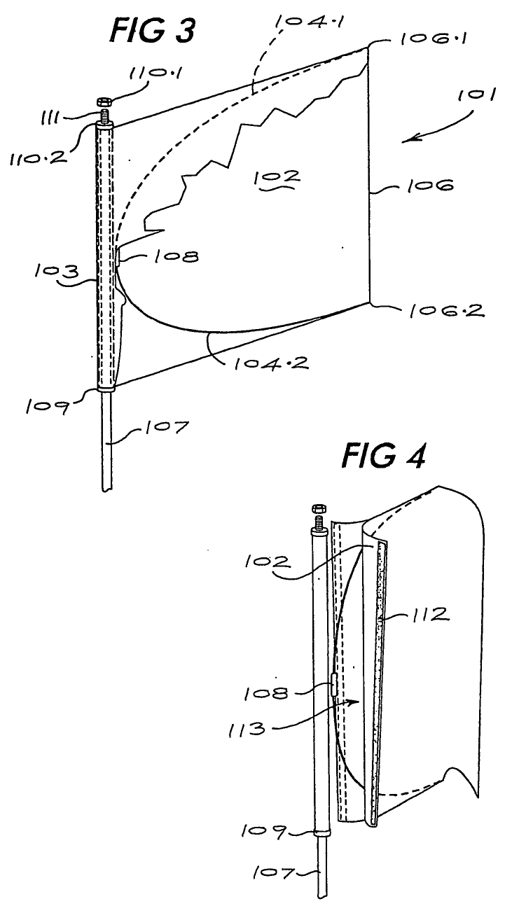

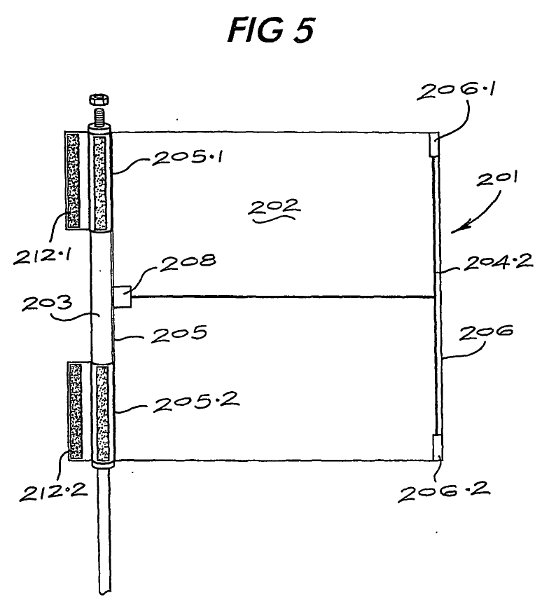

With reference to FIG. 3 and FIG. 4 of the drawings, another embodiment of a flag in accordance with the invention is designated generally by the reference numeral 101 and like reference numerals refer to like components.

The flag 101 is very similar to the structure 1, with a difference being that the membrane is an envelope 102 within which rods 104.1 and 104.2 and sleeve 103 are encapsulated. The free ends of the rods 104.1 and 104.2 are retained in the upper corner 106.1 and lower corner 106.2 of a closed end constituted by the trailing end 106 of the envelope 102, respectively.

The envelope 102 is provided with VELCRO 112 along its opening 113.

The advantage of the flag construction 101 is that information can be displayed on both surfaces of the flag.

Furthermore, when a user wishes only to replace the information displayed on the flag 101, the VELCRO 112 is unfastened and the envelope 102 is removed by pulling it off the rods 104.1 and 104.2. This is particularly advantageous in the advertising industry as information displayed on the flag can be replaced as and when required by the user.

To assemble the flag 101, the distending means, in the form of the rods 104.1 and 104.2, is attached to the sleeve 103 by fixing the rods firmly in place in the collar 108. The free ends of the rods 104.1 and 104.2 are then urged towards each other and the envelope 102 is pulled by its open end, as is illustrated in FIG. 4 of the drawings, until the rods 104.1 and 104.2 and the sleeve 103 are encapsulated within the envelope 102. Fastening the VELCRO 112 then closes the opening of the envelope 102. The sleeve 103 is then slid onto the staff 107 until it is brought to rest by the stop 109, and the sleeve 103 is then retained on the staff 107 by partially tightening the nut 110.1 on the threaded portion 111 via washer 110.2.

To disassemble the flag 101, the nut 110.1 and then the sleeve 103 are removed from the staff 107. The VELCRO 112 is then unfastened to open the envelope 102, which is then removed by pulling it off the rods 104.1 and 104.2. The rods 104.1 and 104.2 are then removed from the collar 108 and the components of the resultant kit can then be stored away.

With reference to FIG. 5 of the drawings, a further embodiment of a flag in accordance with the invention, is designated generally by the reference numeral 201 and like reference numerals refer to like components.

The flag 201 includes a T-piece distending means in the form of rods 204.1 and 204.2. The rod is 204.1 removably fixed to a sleeve 203 via a lug 208 such that the rod 204.1 is held integral with the sleeve 203, and free ends of the rod 204.2 are retained in pockets 206.1 and 206.2 located in the corners of the trailing end 206 of the membrane 202.

The leading end 205 of the membrane 202 is removably attached to the sleeve 203 by means of VELCRO indicated by reference numerals 212.1 and 212.2 provided at an upper end 205.1 and a lower end 205.2, respectively, of the membrane 202.

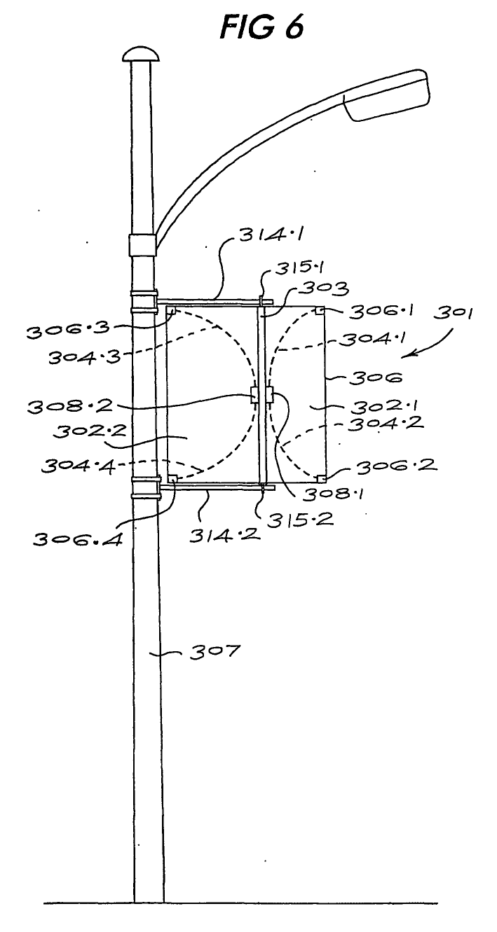

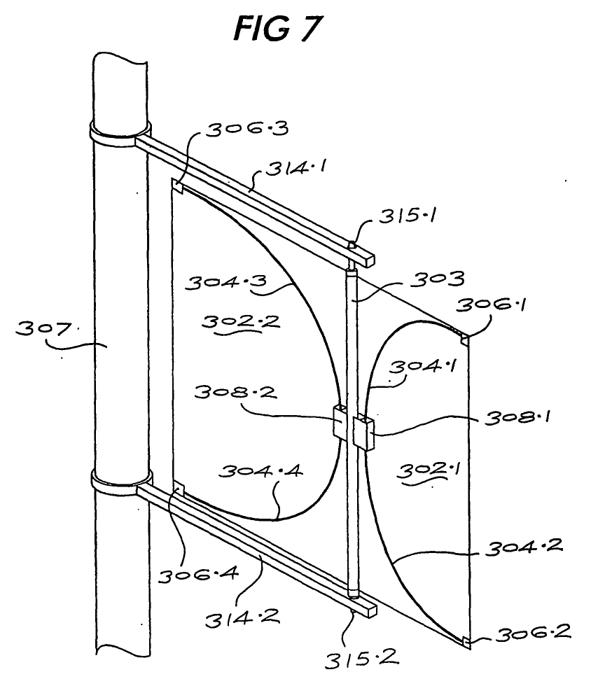

With reference to FIGS. 6 and 7, a further embodiment of the invention, in the form of what is colloquially known as a “boulevard banner”, is designated generally by the reference numeral 301 and like components, as hereinbefore designated by given reference numerals, are again designated by like reference numerals.

The boulevard banner 301 is shown attached to a light pole 307 which, in this embodiment, serves as a flag staff. A shaft 303 is mounted, with its axis parallel to and remote from the axis of the staff 307, on arms 314.1 and 314.2 extending from the pole 307 to which the arms are clamped.

Shaft 303 is so mounted on arms 314.1 and 314.2 via pivots 315.1 and 315.2 about which the shaft 303 is free to rotate.

Membranes 302.1 and 302.2 are removably attached to the shaft 303, in any manner of the kind earlier described herein, on opposite sides of the shaft 303. The parameters of membranes are asymmetrical with the membrane 302.1, which would face the wind in use, having the lesser width.

The membranes 302.1 and 302.2 are held distended by, in the case of membrane 302.1 on the one hand, the fixing ends of rods 304.1 and 304.2 being friction fitted into collar 308.1 mounted on the shaft 303 and the free ends of rods 304.1 and 304.2 being held in pockets 306.1 and 306.2 and, in the case of membrane 302.2 on the other hand, the fixing ends of rods 304.3 and 304.4 being friction fitted into collar 308.2 also mounted on the shaft 303 and the free ends of rods 304.3 and 304.4 being held in pockets 306.3 and 306.4.

Both sides of the boulevard banner are assembled and disassembled in a like manner as in the case of the flags described earlier herein.

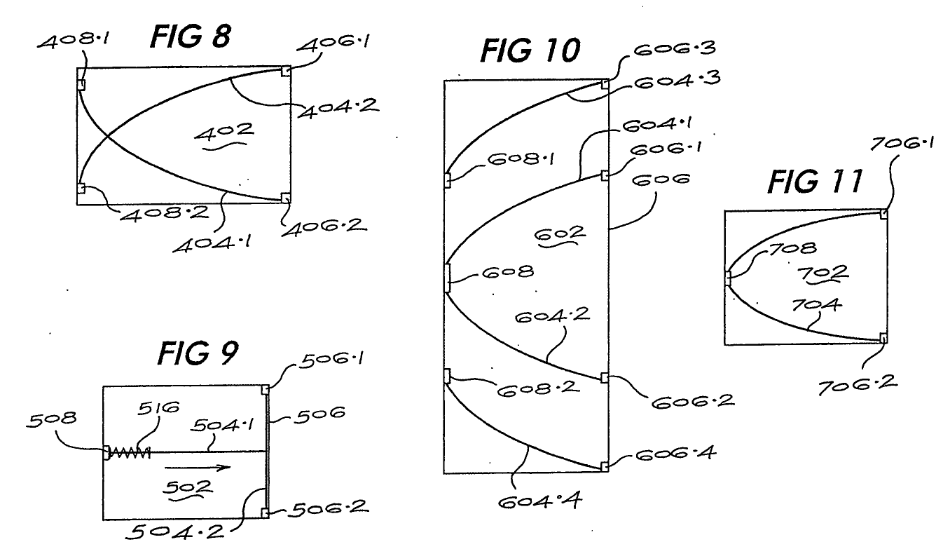

FIGS. 8 to 11 of the drawings show different ways in which the layouts of the distending means of the invention could be configured.

In FIG. 8, rods 404.1 and 404.2 keep membrane 402 distended by their fixing ends being held integral in collars 408.1 and 408.2 mounted on a shaft or sleeve aligned with a flag staff or pole (not shown in any of FIGS. 8 to 11) as described earlier herein and their free ends being held in pockets 406.1 and 406.2 in membrane 402. This is the preferred configuration when the membrane is used to display information in landscape orientation.

FIG. 9 shows a layout of the distending means similar to that illustrated in FIG. 5. In the layout shown in FIG. 9 the distending means consists of rods 504.1 and 504.2 in a T-shaped formation. The fixing end of rod 504.1 is held firmly in collar 508 and the other end is integral with rod 504.2. The free ends of rod 504.2 are held in pockets 506.1 and 506.2 in the membrane 502.

Rod 504.1 is biased, by a well known compression spring device 516 mounted on rod 504.1, from a position away from the collar 508 and towards the trailing end 506 of the membrane 502 as shown by the arrow in FIG. 9. This spring bias assists in keeping the membrane 502 in a distended form.

FIG. 10 illustrates a preferred configuration where the flag or banner is of large dimensions and where additional distending means are required to keep the flag or banner distended.

As shown in FIG. 10, the distending means consists of rods 604.1, 604.2, 604.3 and 604.4. The fixing end of rod 604.1 is located in collar 608 mounted on a flag staff or pole and the free end thereof is housed in pocket 606.1 on the trailing end 606 of membrane 602; the fixing end of rod 604.2 is also located in collar 608 and the free end thereof in pocket 606.2; the fixing end of rod 604.3 is located in collar 608.1 and the free end thereof in pocket 606.3; and the fixing end of rod 604.4 is located in collar 608.2 and in pocket 606.4.

FIG. 11 illustrates an embodiment of invention in which the rod 704 is in a single, continuous form and is held fixed in position by a collar 708 mounted on shaft with the free ends of the rod being housed in pockets 706.1 and 706.2 in the membrane 702

The applicant envisages that the flag construction according to the invention will be suitable for use in displaying advertising material.

More importantly, the flag construction according to the invention allows for the interchangeability of flags.

It will be appreciated that the exact shape and configuration of the flag may be greatly variable while still incorporating the essential features of the invention.

Accordingly, the applicant envisages that the flag construction may also be suitable for displaying advertising information whilst also serving as a wind direction indicator.

1-21. (canceled)

22. A flag for a staff having a longitudinal axis, said flag comprising:
a) a flexible membrane attached to a shaft which is adapted to rotate about an axis of rotation in alignment with said axis of said staff, and
b) distending means for holding said membrane distended normal to the staff and across the plane of the membrane.

23. A flag as defined in claim 22 wherein
said axis of rotation is congruent with said axis of the staff.

24. A flag as defined in claim 22 wherein
said axis of rotation is parallel to and remote from said axis of the staff.

25. A flag as defined in claim 22 including
removable retention means for holding said shaft on its axis of rotation.

26. A flag as defined in claim 22 wherein
said shaft has a structural configuration of a sleeve.

27. A flag as defined in claim 22 including
means for distending said flexible membrane by applying pressure from within said membrane.

28. A flag as defined in claim 22 wherein
said flexible membrane has the structural configuration of an envelope.

29. A flag as defined in claim 22 including
means for removably attaching said flexible membrane to said shaft.

30. A flag as defined in claim 29 wherein
said removably attaching means includes a hook and loop fastener.

31. A flag as defined in claim 29 wherein
said removably attaching means includes a tube formed by a seam provided along a least a portion of the leading end of the membrane with said shaft being disposed in said tube.

32. A flag as defined in claim 22 wherein
said flexible membrane is selected from the group of a textile material, a fabric material, and a plastic material.

33. A flag as defined in claim 22 wherein
said distending means is integral with said shaft.

34. A flag as defined in claim 22 wherein
said distending means is removably fixed to said shaft.

35. A flag as defined in claim 22 wherein
said distending means is pocketed within said membrane.

36. A flexible membrane for use in a flag as defined in any one of claims 22 to 35.

37. A flag kit comprising:
a) a flexible membrane, and means for removable attachment of said membrane to a shaft which is adapted to rotate about an axis of rotation in alignment with a longitudinal axis of a flag staff when in use, and
b) distending means for holding said membrane distended normal to the staff and across the plane of the membrane when in use,
c) said distending means being effective to apply pressure from within said membrane,
d) said shaft including means for fixation of the distending means when in use.
